(19) United States
(12) Patent Application Publication
(10) Pub. No.: US 2021/0004071 A1
(43) Pub. Date: Jan. 7, 2021

(54) SYSTEMS AND METHODS FOR ACCESSORY CHARGING FROM DISPLAY BACKLIGHT

(71) Applicant: Microsoft Technology Licensing, LLC, Redmond, WA (US)

(72) Inventors: Henri A. AUTIO, Redmond, WA (US); Seppo Juhani JAERVENSIVU, Redmond, WA (US); Joni Kristian AROLA, Redmond, WA (US)

(21) Appl. No.: 16/460,322

(22) Filed: Jul. 2, 2019

(51) Int. Cl. G06F 1/26; G09G 3/34; G06F 3/044; G06F 3/0354; G06F 3/0362; G06F 3/038

(52) U.S. Cl. CPC G06F 1/266; G09G 3/3406; G06F 3/044; G06F 3/0442; G06F 3/0362; G06F 3/038; G06F 3/03545

(57) ABSTRACT

An electronic device for optical charging of accessory devices includes a display having a backlight, a control module, a processor, and a hardware storage device. The control module is in data communication with the display and the backlight and configured to control a wavelength and a luminance of the display. The processor is in data communication with the control module. The hardware storage device is in data communication with the processor. The hardware storage device has instructions stored thereon that, when executed by the processor, cause the processor to detect an optically-chargeable accessory device in a location proximate to a portion of the display, identify a charging portion of the display based on the location of the accessory device, and adjust the display to provide output light from the charging portion independently of a remaining portion of the display so as to charge the accessory device.

### BACKGROUND

### Background and Relevant Art

Electronic devices commonly utilize wireless accessory devices to allow users to provide inputs to or interact with the electronic devices. Wireless accessory devices have batteries to power the accessory devices during operation. Conventional systems for charging the accessory devices include charging cables, inductive charging coils, or charging cradles. Each of the conventional charging systems require the user to place the accessory device in a particular location, on a particular cradle, or to take an extra step of plugging the device into a cable.

### BRIEF SUMMARY

In some implementations, an electronic device for optical charging of accessory devices includes a display having a backlight, a control module, a processor, and a hardware storage device. The control module is in data communication with the display and the backlight and configured to control a wavelength and a luminance of the display. The processor is in data communication with the control module. The hardware storage device is in data communication with the processor. The hardware storage device has instructions stored thereon that, when executed by the processor, cause the processor to detect an optically-chargeable accessory device in a location proximate to a portion of the display, identify a charging portion of the display based on the location of the accessory device, and adjust the display to provide output light from the charging portion independently of a remaining portion of the display so as to charge the accessory device.

In some implementations, a method of providing power to an accessory device with a display of an electronic device includes, at the electronic device, detecting the accessory device in proximity to a portion of the display of the electronic device, adjusting the display to provide output light from a charging portion of the display in proximity to the accessory device independently of a remaining portion of the display to charge the accessory device, and communicating with the accessory device to determine when charging is complete.

In some implementations, an electronic device for optical charging of accessory devices includes a display having a backlight, an accessory device, a control module, a processor, and a hardware storage device. The accessory device is positioned in contact with the display and has a photovoltaic panel on a contact surface thereof. The control module is in data communication with the display and the backlight and configured to control a wavelength and a luminance of the display. The processor is in data communication with the control module. The hardware storage device is in data communication with the processor. The hardware storage device has instructions stored thereon that, when executed by the processor, cause the processor to detect the accessory device in a location proximate to a portion of the display, adjust the display to provide output light from the charging portion independently of a remaining portion of the display so as to charge the accessory device, and communicate with the accessory device to determine when charging is complete.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a front view of an electronic device having a plurality of accessory devices;

FIG. 2 is a schematic system diagram of an electronic device in data communication with an accessory device;

FIG. 3-1 is a side cross-sectional view of an accessory device positioned on a display;

FIG. 3-2 is a front view of a display with a charging portion;

FIG. 3-3 is a rear view of an accessory device with a photovoltaic panel;

FIG. 4 is a flowchart illustrating a method of optically charging an accessory device;

FIG. 5-1 is a front schematic view of a capacitive pattern of an accessory device on a display;

FIG. 5-2 is a front schematic view of an output light in a charging portion of a display;

FIG. 5-3 is a front schematic view of an accessory device on a display with an output light obscured by the accessory device;

FIG. 5-4 is a front schematic view of a charged capacitive pattern of an accessory device on a display; and

FIG. 6 is a side cross-sectional view of an accessory device optically communicating with an electronic device through a display of the electronic device.

### DETAILED DESCRIPTION

This disclosure generally relates to devices, systems, and methods for charging an accessory device for an electronic device. More particularly, the present disclosure relates to optically charging an accessory device with a display of an electronic device. In some implementations, an electronic device (e.g., a liquid crystal display device) has a display with a backlight that produces an output light. The output light illuminates the display and allows a user to view the display in any lighting condition. In some examples, a wireless accessory device has a battery that powers the accessory device. For example, a user with a controller and a smart display may mount the controller to the screen of their smart display when they are not using the controller. In this example, the controller includes a battery and a photovoltaic panel for charging the battery. The smart display in this example detects that the controller is mounted to a particular portion (and in need of charging) and will operate the pixels in that portion of the screen so as to charge the controller. In this example, the pixels in that portion of the screen are operated independently of other portions of the screen. For example, the smart display may be in a sleep or standby mode where the other portions of the screen are off, or the smart display may be displaying a particular UI, visual information, or video in other portions of the screen. In this example, once the controller is charged, or removed from the screen, the pixels in that portion synchronize with (e.g., go back to operating in conjunction with) the other portions of the screen.

In some implementations, the accessory device includes a photovoltaic panel to convert light to an electrical current to charge the accessory device. The output light of the display can be provided to the accessory device when the accessory device is placed in proximity to the display. In some implementations, the electronic device detects the presence and shape of the accessory device, and the display provides an output light in a charging portion of the display only. In other implementations, the electronic device is in data communication with the accessory device and the accessory device communicates device information to the electronic device that includes a size and shape of the accessory device. In some implementations, the charging portion of the display is smaller than a contact area of the accessory device with the display to limit and/or prevent the bleeding of the output light around the edges of the accessory device.

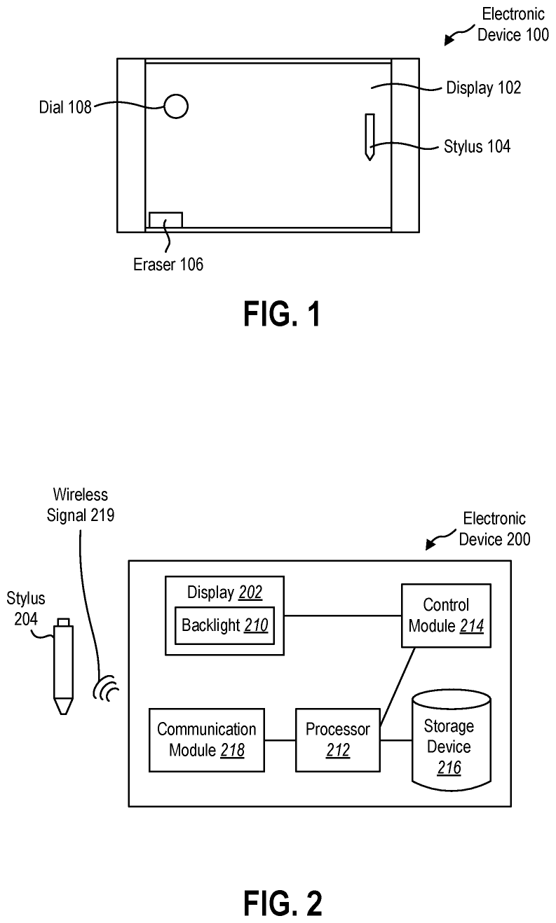

FIG. 1 is a front view of an implementation of an electronic device 100. While a large format all-in-one computing device is illustrated in FIG. 1 and will be referenced herein, it should be understood that an electronic device according to the present disclosure can be an electronic device with a display that produces an output light. In some implementations, the electronic device is a laptop, a desktop computer, a tablet computer, a smartphone, a television, a computer monitor, or other electronic device with an illuminated display. In some embodiments, a large format all-in-one or large format display is used in a conference room or other presentation room where a number of accessory devices are used to interact with the electronic device 100. With multiple users interacting with the electronic device 100 and accessory devices, a simple storage and charging solution can ensure the accessory devices are always charged by making the charging process intuitive, transparent, and simple.

The electronic device 100 has a display 102 that can produce an output light to allow a user to view visual information presented on the display 102. Various accessory devices are illustrated on the electronic device 100 including a stylus 104, a digital eraser 106, and a dial 108 (such as a MICROSOFT SURFACE DIAL). Other examples of accessory devices include a remote control, keyboard, or other input device, wireless audio devices such as headphones or BLUETOOTH speakers, laser pointers, other pointing devices, a presentation slide controller, a game controller, or other wireless accessory devices. In some implementations, the output light of the display 102 charges the accessory devices. In some examples, the accessory devices are used for only a portion of the time, allowing the accessory devices to charge the remaining time that the accessory devices are stored in or on the display 102 of the electronic device 100.

FIG. 2 is a schematic illustration of an implementation of an electronic device 200 according to the present disclosure. In some implementations, the electronic device 200 includes a display 202 with a backlight 210 therein. The electronic device 200 includes a processor 212 in data communication with a control module 214 that controls the display 202 and the backlight 210. The processor 212 is further in data communication with a hardware storage device 216 and a communication module 218. The hardware storage device 216 has instructions stored thereon that, when executed by the processor 212, cause the processor 212 to execute any of the methods or parts of the methods described herein. In other implementations, the processor 212 is in data communication with a remotely located hardware storage device, such as via a network.

In some implementations, the hardware storage device 216 is a solid-state storage medium. In some examples, the hardware storage device 216 is a volatile storage medium, such as dynamic random-access memory (DRAM). In other examples, the hardware storage device 216 is a non-volatile storage medium, such as electrically erasable programmable read-only memory or flash memory (NAND- or NOR-type). In other implementations, the hardware storage device 216 is a platen-based storage medium, such as a magnetic platen-based hard disk drive. In yet other implementations, the hardware storage device 216 is an optical storage medium, such as a compact disc, digital video disc, BLURAY disc, or other optical storage format.

In some implementations, the communication module 218 is a wireless communication module. In some examples, the communication module 218 provides a wireless signal 219 to communicate with an accessory device, such as a stylus 204. In some implementations, the communication module 218 is a BLUETOOTH communication module. In other implementations, the communication module 218 is a WI-FI communication module. In yet other implementations, the communication module 218 is a near field communications (NFC) communication module.

In further implementations, the communication module 218 is an optical communication module. For example, an optical communication module may communicate with the accessory device through a series of optical pulses that are transmitted and received in either direction between the accessory device and the communication module 218. In some examples, the display 202 can emit optical communication signals that are received by the accessory device, and the accessory device emits optical communication signals that are received by photoreceptors in the display 202. In at least one example, the communication from the electronic device 200 to the accessory device uses a different communication medium or frequency than communication from the accessory device to the electronic device 200. For example, the display 202 emits an optical communication signal to the accessory device, which then communicates a response to the electronic device 200 via a radio frequency wireless signal.

In yet other implementations, the communication between the electronic device 200 and the accessory device occurs via detection of a capacitive pattern of the accessory device on the display 202. In some examples, the display 202 includes a touch-sensitive panel that can detect changes in capacitance on a surface of the display 202. In such examples, the accessory device has a capacitive pattern that can change to communicate different device states (e.g., paired, charging, charged).

In some implementations, the electronic device 200 further includes additional computer components, such as system memory, a graphical processing unit, graphics memory, speakers, one or more additional communication devices (such as WIFI, BLUETOOTH, near-field communications, cellular), peripheral connection points, etc.

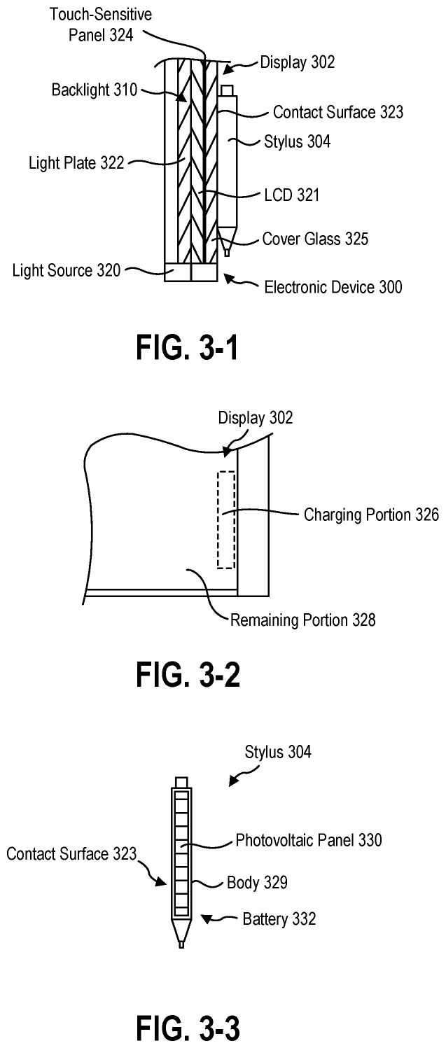

FIG. 3-1 through FIG. 3-3 illustrate an implementation of a stylus 304 in contact with a surface of a display 302 to optically charge the stylus 304. While a stylus is illustrated and described, it should be understood that the associated description is applicable to any accessory device and/or form factor. FIG. 3-1 is a side cross-sectional view of a display 302 with a stylus 304 contacting an outer surface of the display 302. In some implementations, the stylus 304 (or other accessory device) is held on the display 302 by a magnetic force between the stylus 304 and a portion of the display 302 and/or electronic device 300. In other implementations, the stylus 304 is held on the display 302 by a suction between a portion of the stylus 304 and the surface of the display 302. In yet other implementations, the stylus 304 is held on the display 302 by a mechanical fastener, such as a clip, clamp, strap, latch, or other mechanism.

The stylus 304 receives light from the display 302 generated by a backlight 310. In some implementations, the backlight 310 includes a light source 320 and a light plate 322 that guides the light from the source 320 across the area of the display 302. The display 302 then uses a liquid crystal display (LCD) 321 that alters the color and/or brightness of the light emitted from the light plate 322 to create an image. In other implementations, the backlight 310 includes an array of light sources 320, such as light emitting diodes (LEDs) that illuminate portions of the display 302. In some examples, the array of LEDs contains different colored LEDs.

In some implementations, the backlight 310 can provide an output light to at least a portion of the display 302 defined by a contact surface 323 of the stylus 304 on the cover glass 325. In some examples, the size and/or shape of the contact surface 323 is measured by a touch-sensitive panel 324 in the display 302. For example, the touch-sensitive panel 324 can measure the area of the contact surface 323 that applies a pressure to the touch-sensitive panel 324. In other examples, the touch-sensitive panel 324 measures a capacitance change in the surface of the display 302 when the stylus 304 contacts the display 302. The stylus 304 (or other accessory device) can have a unique capacitance pattern that is detected by the display 302, and the capacitance pattern informs the electronic device 300 of the size and/or shape of the contact surface 323.

FIG. 3-2 illustrates the display 302 of FIG. 3-1 in a front view with the stylus removed to show the portion of the display 302 that the stylus contacts. In some implementations, the portion of the display 302 that the contact surface of the stylus contacts is the charging portion 326 of the display 302. In some implementations, the charging portion 326 is a pre-designated portion of the display 302. For example, a display may have designated a bottom corner of the display to be used for optical charging. In some implementations, the charging portion 326 is dynamically determined based on the location of the stylus (chargeable accessory).

The display 302 (e.g., via the control module) can emit an output light in the charging portion 326 to provide energy to the stylus to charge the stylus independently of the remaining portion 328.

In some implementations, the remaining portion 328 of the display 302 can be used to provide visual information to a user independently of the charging portion 326. In some examples, the charging portion 326 emits an output light that is adjusted to charge the accessory device efficiently based upon the photovoltaic panel of the accessory device. In some implementations, the output light of the charging portion 326 is emitted at the maximum luminance of the display 302. In other implementations, a wavelength of the output light of the charging portion 326 is adjusted to provide the greatest efficiency based on the photovoltaic panel of the accessory device.

In some implementations, the luminance of the output light of the charging portion 326 is in a range having an upper value, a lower value, or upper and lower values including any of 500 lux, 600 lux, 700 lux, 800 lux, 900 lux, 1000 lux, 1100 lux, 1200 lux, 1300 lux, 1400 lux, 1500 lux, or any values therebetween. In some examples, the luminance of the charging portion 326 is greater than 500 lux. In other examples, the luminance of the charging portion 326 is less than 1500 lux. In yet other examples, the luminance of the charging portion 326 is between 500 lux and 1500 lux. In at least one example, the luminance of the charging portion 326 is about 1000 lux.

In some implementations, the output light of the charging portion is a red light. In other implementations, the output light of the charging portion is a blue light. In yet other implementations, the output light of the charging portion is an ultraviolet light. In further implementations, the output light of the charging portion is a white light.

FIG. 3-3 illustrates the implementation of a stylus 304 of FIG. 3-1. In some implementations, the stylus 304 or other accessory device has a body 329 that supports a photovoltaic panel 330. The photovoltaic panel 330 is in electrical communication with a battery 332 of the stylus 304 to charge the battery 332. The photovoltaic panel 330 is located on the contact surface 323 of the stylus 304.

The photovoltaic panel 330 covers at least a portion of the contact surface 323. In some implementations, the photovoltaic panel 330 covers the contact surface 323. In other implementations, the photovoltaic panel 330 covers more of the body 329 than just the contact surface 323. In yet other implementations, the photovoltaic panel 330 covers less than 100% of the area of the contact surface 323. In some examples, the photovoltaic panel 330 covers a percentage of the area of the contact surface 323 in a range having an upper value, a lower value, or upper and lower values including any of 20%, 30%, 40%, 50%, 60%, 70%, 80%, 90%, 100%, or any values therebetween. For example, the photovoltaic panel 330 covers greater than 20% of the area of the contact surface 323. In other examples, the photovoltaic panel 330 covers less than 100% of the area of the contact surface 323. In yet other examples, the photovoltaic panel 330 covers greater than 50% of the area of the contact surface 323. In at least one example, the photovoltaic panel 330 covers greater than 80% of the area of the contact surface 323.

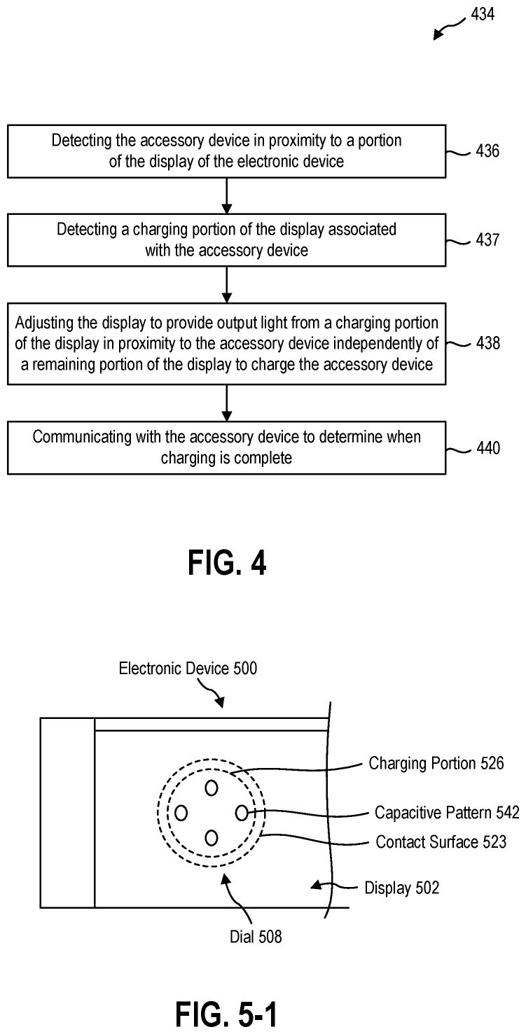

The display can adjust the output light of the display, both spatially and in luminance and/or wavelength, to charge an accessory device with a photovoltaic panel. FIG. 4 is a flowchart illustrating an implementation of a method 434 for charging an accessory device. The method 434 includes detecting the accessory device in proximity to a portion of the display of the electronic device at 436. In some implementations, the accessory device is detected by a radio frequency (RF) signal and/or communication between the electronic device and the accessory device. In some examples, the RF signal is a BLUETOOTH signal. In other examples, the RF signal is a Wi-Fi signal. In yet other examples, the RF signal is a NFC signal. In at least one example, the RF signal communicates an electronic device identification (EDID) to the electronic device that includes device information, such as size, shape, photovoltaic panel size, photovoltaic panel shape, photovoltaic panel location, battery capacity, or other device information.

In other implementations the accessory device is detected by a contact with the surface of the display. In some examples, the accessory device is detected by a capacitive touch-sensitive panel in the display. The capacitive touch-sensitive panel detects the location of the accessory device on the display. A capacitive pattern of the accessory device can uniquely identify the accessory device, allowing the electronic device to identify the accessory device in a device database. In some implementations, the device database includes device information such as size, shape, photovoltaic panel size, photovoltaic panel shape, photovoltaic panel location, battery capacity, or other device information.

The method 434 further includes detecting a charging portion of the display associated with the accessory device at 437 and adjusting the display to provide output light from the charging portion of the display in proximity to the accessory device independently of a remaining portion of the display to charge the accessory device at 438. In some implementations, adjusting the display includes adjusting the backlight to increase the amount of output light. In some implementations, a luminance of the output light of the charging portion is in a range having an upper value, a lower value, or upper and lower values including any of 500 lux, 600 lux, 700 lux, 800 lux, 900 lux, 1000 lux, 1100 lux, 1200 lux, 1300 lux, 1400 lux, 1500 lux, or any values therebetween. In some examples, the luminance of the charging portion is greater than 500 lux. In other examples, the luminance of the charging portion is less than 1500 lux. In yet other examples, the luminance of the charging portion is between 500 lux and 1500 lux. In at least one example, the luminance of the charging portion is about 1000 lux.

In some implementations, adjusting the display includes adjusting a wavelength of the output light. In some examples, the output light of the charging portion is a red light. In other examples, the output light of the charging portion is a blue light. In yet other examples, the output light of the charging portion is an ultraviolet light. In further examples, the output light of the charging portion is a white light. In some implementations, the wavelength of the output light is related to the photovoltaic panel and the peak efficiency of the photovoltaic panel. In some examples, the device information provides the display with a peak efficiency wavelength of the photovoltaic panel of the accessory device.

The charging portion of the display is related to the size and shape of the accessory device. In some implementations, the charging portion is sized and shaped to be complementary to the size and shape of a contact surface of the accessory device. In other implementations, the charging portion is sized and shaped to be complementary to the size and shape of a photovoltaic panel of the accessory device.

The charging portion can be the same size and shape as the contact surface. In some implementations, the charging portion is less than 100% of the area of the contact surface. In some examples, adjusting the display includes illuminating a charging portion that is less than 90% of the area of the contact surface. In other examples, adjusting the display includes illuminating a charging portion that is less than 80% of the area of the contact surface. In yet other examples, adjusting the display includes illuminating a charging portion that is less than 70% of the area of the contact surface. In at least one example, the charging portion is greater than 50% and less than 95% of the area of the contact surface.

The charging portion can be the same size and shape as the photovoltaic panel of the accessory device. In some implementations, the charging portion is less than 100% of the area of the photovoltaic panel. In some examples, adjusting the display includes illuminating a charging portion that is less than 90% of the area of the photovoltaic panel. In other examples, adjusting the display includes illuminating a charging portion that is less than 80% of the area of the photovoltaic panel. In yet other examples, adjusting the display includes illuminating a charging portion that is less than 70% of the area of the photovoltaic panel. In at least one example, the charging portion is greater than 50% and less than 95% of the area of the photovoltaic panel.

The remaining portion of the display can be used as the display normally is while the charging portion emits an output light to charge the accessory device. In some implementations, the remaining portion of the display provides visual information to a user, such as an operating system desktop, a video, various software applications, or other visual information provided by the processor and/or graphics processor. In at least one example, the remaining portion displays a screen saver. In at least another example, a remaining portion is in a standby mode where the remaining portion is black or unilluminated.

The method 434 also includes communicating with the accessory device to determine when charging is complete at 440. Overcharging a battery can damage the battery and shorten the operational lifetime of the battery. In some implementations, the electronic device communicates with the accessory device to determine when charging is complete and subsequently stops emitting the output light and/or synchronizes the display of the charging portion to the remaining portion, such that the display presents a continuous and complete display of the visual information and/or standby screen.

In some implementations, communicating with the accessory device includes using an RF signal to communicate data to and/or from the accessory device. For example, the RF signal can be a BLUETOOTH signal, a WIFI signal, an NFC signal, or another RF signal. In other implementations, communicating with the accessory device includes detecting a capacitance pattern of the accessory device with a touch-sensitive or capacitive panel in the display. In yet other implementations, communicating with the accessory device includes using an optical signal to communicate data to and/or from the accessory device.

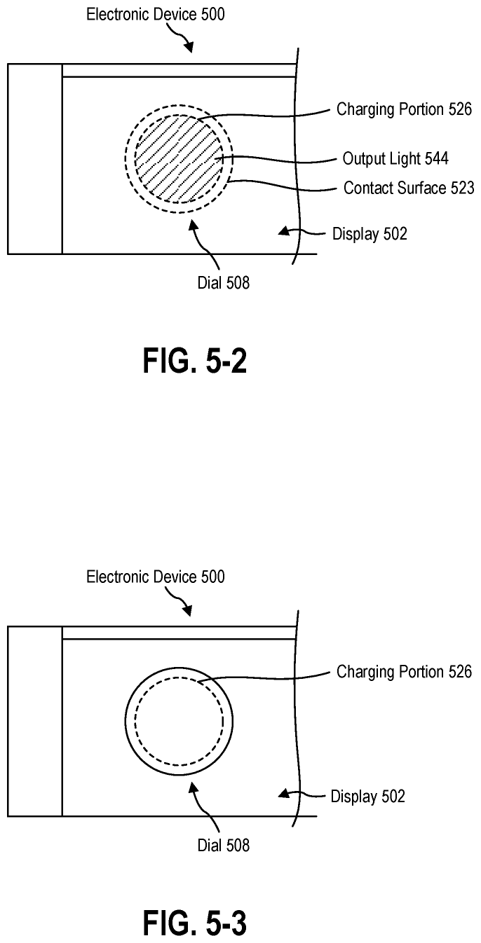

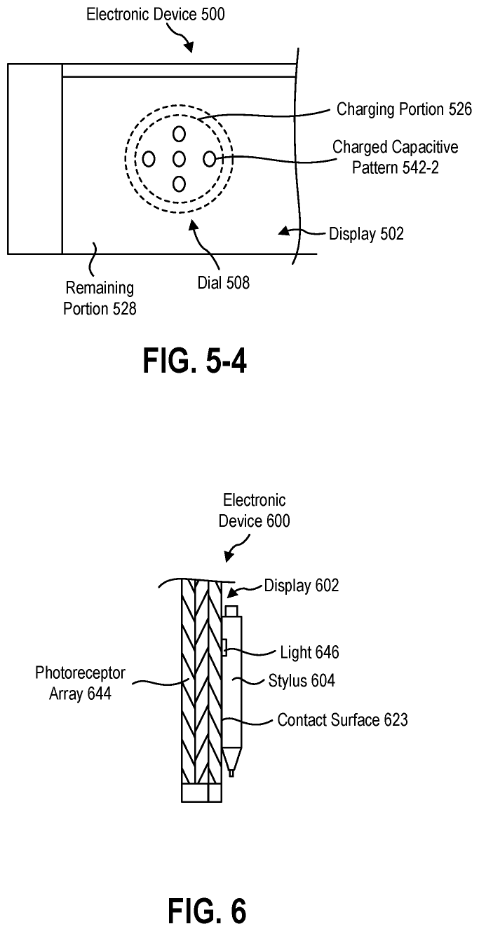

FIG. 5-1 through FIG. 5-4 illustrate an implementation of charging an accessory device with communication via a capacitive pattern. FIG. 5-1 is a schematic representation of a corner of an electronic device 500. The electronic device 500 includes a display 502, and a dial 508 (or other accessory device) is positioned on the display 502. In some implementations, the dial 508 has a unique capacitive pattern 542 that is detected by a capacitive panel (such as the touch-sensitive panel 324 described in relation to FIG. 3-1) in the display 502. The processor of the electronic device can compare the capacitive pattern to a device database, stored on a local storage device or on a remote storage device, to identify the accessory device and access device information about the accessory device. The device information informs the electronic device of a contact surface 523 size and shape of the dial 508.

As shown in FIG. 5-1, in some implementations, the area of the charging portion 526 of the display 502 is smaller than the area of the contact surface 523. In some examples, the charging portion 526 is within a perimeter of the contact surface 523 to limit and/or prevent light bleed of an output light from underneath and/or around the dial 508.

For example, in FIG. 5-2, the charging portion 526 is illustrated as illuminated by an output light 544 that is within a perimeter of the contact surface 523. The display 502 can, thereby, provide the output light 544 to the dial 508 while no extraneous output light 544 is visible to a user, as illustrated in FIG. 5-3. Additionally, and referring back to FIG. 5-2, light bleed indicates that a portion of the output light 544 is not directed at or collected by the photovoltaic panel of the accessory device. In such instances, the portion of the output light 544 that bleeds around the accessory device is wasted energy that is not being harvested to charge the accessory device. Additionally, by providing the output light 544 in only the charging portion 526 of the display 502, the electronic device 500 consumes less energy and charges the accessory device more efficiently that merely positioning a photovoltaic-powered accessory device at or near a conventional display.

Referring now to FIG. 5-4, when the dial 508 is fully charged, the electronic device 500 communicates with the dial 508 to determine that the dial 508 is charged. In some implementations, a capacitive pattern changes into a charged capacitive pattern 542-2 to indicate the dial 508 is charged. The display 502 detects the charged capacitive pattern 542-2, and, recognizing the capacitive pattern has changed, then stops emitting the output light to charge the dial 508.

In some implementations, when the display 502 stops emitting the output light in the charging portion 526, the electronic device 500 synchronizes the display 502 in the charging portion and in the remaining portion 528. The display 502 then displays continuous visual information across the entire display 502 after the accessory device is charged.

In other implementations, the communication between the accessory device and the electronic device when the accessory device is charged includes receiving an optical signal from the accessory device. FIG. 6 is a side cross-sectional view of a display 602 with a photoreceptor array 644 or other photosensitive panel. In some implementations, the stylus 604 or other accessory device has a light 646 therein that is oriented in the direction of the contact surface 623. The light 646 illuminates and/or flashes to communicate an optical signal to the display 602 that is detected by the photoreceptor array 644. The photoreceptor array 644 can then communicate to the control module and/or processor of the electronic device 600 that the stylus 604 is charged.

### INDUSTRIAL APPLICABILITY

This disclosure generally relates to systems and methods for optically charging an accessory device using light from a display of an electronic device. In some implementations, an electronic device has a display with a backlight that produces an output light. The output light illuminates the display and allows a user to view the display in any lighting condition. In some examples, a wireless accessory device has a battery that powers the accessory device.

In some implementations, the accessory device includes a photovoltaic panel to convert light to an electrical current to charge the accessory device. The output light of the display can be provided to the accessory device when the accessory device is placed in proximity to the display. In some implementations, the electronic device detects the presence and shape of the accessory device, and the display provides an output light in a charging portion of the display only. In other implementations, the electronic device is in data communication with the accessory device and the accessory device communicates device information to the electronic device that includes a size and shape of the accessory device. In some implementations, the charging portion of the display is smaller than a contact area of the accessory device with the display to limit and/or prevent the bleeding of the output light around the edges of the accessory device.

An electronic device according to the present disclosure can be an electronic device with a display that produces an output light. In some implementations, the electronic device is a large-format all-in-one computer, a laptop, a desktop computer, a tablet computer, a smartphone, a television, a computer monitor, or other electronic device with an illuminated display.

The electronic device has a display that can produce an output light to allow a user to view visual information presented on the display. Various accessory devices on the electronic device can include a stylus, a digital eraser, and a dial (such as a MICROSOFT SURFACE DIAL). Other examples of accessory devices include a remote control, keyboard, or other input device, wireless audio devices such as headphones or BLUETOOTH speakers, laser pointers, other pointing devices, a presentation slide controller, a game controller, or other wireless accessory devices. In some implementations, the output light of the display charges the accessory devices. In some examples, the accessory devices are used for only a portion of the time, allowing the accessory devices to charge the remaining time that the accessory devices are stored in or on the display of the electronic device.

In some implementations, the electronic device includes a display with a backlight therein. The electronic device includes a processor in data communication with a control module that controls the display and the backlight. The processor is further in data communication with a hardware storage device and a communication module. The hardware storage device has instructions stored thereon that, when executed by the processor, cause the processor to execute any of the methods or parts of the methods described herein. In other implementations, the processor is in data communication with a remotely located hardware storage device, such as via a network.

In some implementations, the hardware storage device is a solid-state storage medium. In some examples, the hardware storage device is a volatile storage medium, such as dynamic random-access memory (DRAM). In other examples, the hardware storage device is a non-volatile storage medium, such as electrically erasable programmable read-only memory or flash memory (NAND- or NOR-type). In other implementations, the hardware storage device is a platen-based storage medium, such as a magnetic platen-based hard disk drive. In yet other implementations, the hardware storage device is an optical storage medium, such as a compact disc, digital video disc, BLURAY disc, or other optical storage format.

In some implementations, the communication module is a wireless communication module. In some examples, the communication module provides a wireless signal to communicate with an accessory device, such as a stylus. In some implementations, the communication module is a BLUETOOTH communication module. In other implementations, the communication module is a WI-FI communication module. In yet other implementations, the communication module is a near field communications (NFC) communication module.

In further implementations, the communication module is an optical communication module. For example, an optical communication module may communicate with the accessory device through a series of optical pulses that are transmitted and received in either direction between the accessory device and the communication module. In some examples, the display can emit optical communication signals that are received by the accessory device, and the accessory device emits optical communication signals that are received by photoreceptors in the display. In at least one example, the communication from the electronic device to the accessory device uses a different communication medium or frequency than communication from the accessory device to the electronic device. For example, the display emits an optical communication signal to the accessory device, which then communicates a response to the electronic device via a radio frequency wireless signal.

In yet other implementations, the communication between the electronic device and the accessory device occurs via detection of a capacitive pattern of the accessory device on the display. In some examples, the display includes a touch-sensitive panel that can detect changes in capacitance on a surface of the display. In such examples, the accessory device has a capacitive pattern that can change to communicate different device states (e.g., paired, charging, charged).

In some implementations, the electronic device further includes additional computer components, such as system memory, a graphical processing unit, graphics memory, speakers, one or more additional communication devices (such as WIFI, BLUETOOTH, near-field communications, cellular), peripheral connection points, etc.

In some implementations, the stylus (or other accessory device) is held on the display by a magnetic force between the stylus and a portion of the display and/or electronic device. In other implementations, the stylus is held on the display by a suction between a portion of the stylus and the surface of the display. In yet other implementations, the stylus is held on the display by a mechanical fastener, such as a clip, clamp, strap, latch, or other mechanism.

The stylus receives light from the display generated by a backlight. In some implementations, the backlight includes a light source and a light plate that guides the light from the source across the area of the display. The display then alters the color and/or brightness of the light emitted from the light plate to create an image. In other implementations, the backlight includes an array of light sources, such as light emitting diodes (LEDs) that illuminate portions of the display. In some examples, the array of LEDs contains different colored LEDs.

In some implementations, the backlight can provide an output light to at least a portion of the display defined by a contact surface of the stylus. In some examples, the size and/or shape of the contact surface is measured by a touch-sensitive panel in the display. For example, the touch-sensitive panel can measure the area of the contact surface that applies a pressure to the touch-sensitive panel. In other examples, the touch-sensitive panel measures a capacitance change in the surface of the display when the stylus contacts the display. The stylus (or other accessory device) can have a unique capacitance pattern that is detected by the display, and the capacitance pattern informs the electronic device of the size and/or shape of the contact surface.

In some implementations, the portion of the display that the contact surface of the stylus contacts is the charging portion of the display. The display (e.g., via the control module) can emit an output light in the charging portion to provide energy to the stylus to charge the stylus independently of the remaining portion.

In some implementations, the remaining portion of the display can be used to provide visual information to a user independently of the charging portion. In some examples, the charging portion emits an output light that is adjusted to charge the accessory device efficiently based upon the photovoltaic panel of the accessory device. In some implementations, the output light of the charging portion is emitted at the maximum luminance of the display. In other implementations, a wavelength of the output light of the charging portion is adjusted to provide the greatest efficiency based on the photovoltaic panel of the accessory device.

In some implementations, the luminance of the output light of the charging portion is in a range having an upper value, a lower value, or upper and lower values including any of 500 lux, 600 lux, 700 lux, 800 lux, 900 lux, 1000 lux, 1100 lux, 1200 lux, 1300 lux, 1400 lux, 1500 lux, or any values therebetween. In some examples, the luminance of the charging portion is greater than 500 lux. In other examples, the luminance of the charging portion is less than 1500 lux. In yet other examples, the luminance of the charging portion is between 500 lux and 1500 lux. In at least one example, the luminance of the charging portion is about 1000 lux.

In some implementations, the output light of the charging portion is a red light. In other implementations, the output light of the charging portion is a blue light. In yet other implementations, the output light of the charging portion is an ultraviolet light. In further implementations, the output light of the charging portion is a white light.

In some implementations, the stylus or other accessory device has a body that supports a photovoltaic panel. The photovoltaic panel is in electrical communication with a battery of the stylus to charge the battery. The photovoltaic panel is located on the contact surface of the stylus.

The photovoltaic panel covers at least a portion of the contact surface. In some implementations, the photovoltaic panel covers the contact surface. In other implementations, the photovoltaic panel covers more of the body than just the contact surface. In yet other implementations, the photovoltaic panel covers less than 100% of the area of the contact surface. In some examples, the photovoltaic panel covers a percentage of the area of the contact surface in a range having an upper value, a lower value, or upper and lower values including any of 20%, 30%, 40%, 50%, 60%, 70%, 80%, 90%, 100%, or any values therebetween. For example, the photovoltaic panel covers greater than 20% of the area of the contact surface. In other examples, the photovoltaic panel covers less than 100% of the area of the contact surface 323. In yet other examples, the photovoltaic panel covers greater than 50% of the area of the contact surface. In at least one example, the photovoltaic panel covers greater than 80% of the area of the contact surface.

The display can adjust the output light of the display, both spatially and in luminance and/or wavelength, to charge an accessory device with a photovoltaic panel. In some implementations, a method for charging an accessory device includes detecting the accessory device in proximity to a portion of the display of the electronic device. In some implementations, the accessory device is detected by an RF signal and/or communication between the electronic device and the accessory device. In some examples, the RF signal is a BLUETOOTH signal. In other examples, the RF signal is a Wi-Fi signal. In yet other examples, the RF signal is a NFC signal. In at least one example, the RF signal communicates an electronic device identification (EDID) to the electronic device that includes device information, such as size, shape, photovoltaic panel size, photovoltaic panel shape, photovoltaic panel location, battery capacity, or other device information.

In other implementations the accessory device is detected by a contact with the surface of the display. In some examples, the accessory device is detected by a capacitive touch-sensitive panel in the display. The capacitive touch-sensitive panel detects the location of the accessory device on the display. A capacitive pattern of the accessory device can uniquely identify the accessory device, allowing the electronic device to identify the accessory device in a device database. In some implementations, the device database includes device information such as size, shape, photovoltaic panel size, photovoltaic panel shape, photovoltaic panel location, battery capacity, or other device information.

The method further includes adjusting the display to provide output light from a charging portion of the display in proximity to the accessory device independently of a remaining portion of the display to charge the accessory device. In some implementations, adjusting the display includes adjusting the backlight to increase the amount of output light. In some implementations, a luminance of the output light of the charging portion is in a range having an upper value, a lower value, or upper and lower values including any of 500 lux, 600 lux, 700 lux, 800 lux, 900 lux, 1000 lux, 1100 lux, 1200 lux, 1300 lux, 1400 lux, 1500 lux, or any values therebetween. In some examples, the luminance of the charging portion is greater than 500 lux. In other examples, the luminance of the charging portion is less than 1500 lux. In yet other examples, the luminance of the charging portion is between 500 lux and 1500 lux. In at least one example, the luminance of the charging portion is about 1000 lux.

In some implementations, adjusting the display includes adjusting a wavelength of the output light. In some examples, the output light of the charging portion is a red light. In other examples, the output light of the charging portion is a blue light. In yet other examples, the output light of the charging portion is an ultraviolet light. In further examples, the output light of the charging portion is a white light. In some implementations, the wavelength of the output light is related to the photovoltaic panel and the peak efficiency of the photovoltaic panel. In some examples, the device information provides the display with a peak efficiency wavelength of the photovoltaic panel of the accessory device.

The charging portion of the display is related to the size and shape of the accessory device. In some implementations, the charging portion is sized and shaped to be complementary to the size and shape of a contact surface of the accessory device. In other implementations, the charging portion is sized and shaped to be complementary to the size and shape of a photovoltaic panel of the accessory device.

The charging portion can be the same size and shape as the contact surface. In some implementations, the charging portion is less than 100% of the area of the contact surface. In some examples, adjusting the display includes illuminating a charging portion that is less than 90% of the area of the contact surface. In other examples, adjusting the display includes illuminating a charging portion that is less than 80% of the area of the contact surface. In yet other examples, adjusting the display includes illuminating a charging portion that is less than 70% of the area of the contact surface. In at least one example, the charging portion is greater than 50% and less than 95% of the area of the contact surface.

The charging portion can be the same size and shape as the photovoltaic panel of the accessory device. In some implementations, the charging portion is less than 100% of the area of the photovoltaic panel. In some examples, adjusting the display includes illuminating a charging portion that is less than 90% of the area of the photovoltaic panel. In other examples, adjusting the display includes illuminating a charging portion that is less than 80% of the area of the photovoltaic panel. In yet other examples, adjusting the display includes illuminating a charging portion that is less than 70% of the area of the photovoltaic panel. In at least one example, the charging portion is greater than 50% and less than 95% of the area of the photovoltaic panel.

The remaining portion of the display can be used as the display normally is while the charging portion emits an output light to charge the accessory device. In some implementations, the remaining portion of the display provides visual information to a user, such as an operating system desktop, a video, various software applications, or other visual information provided by the processor and/or graphics processor. In at least one example, the remaining portion displays a screen saver. In at least another example, a remaining portion is in a standby mode where the remaining portion is black or unilluminated.

The method also includes communicating with the accessory device to determine when charging is complete. Overcharging a battery can damage the battery and shorten the operational lifetime of the battery. In some implementations, the electronic device communicates with the accessory device to determine when charging is complete and subsequently stops emitting the output light and/or synchronizes the display of the charging portion to the remaining portion, such that the display presents a continuous and complete display of the visual information and/or standby screen.

In some implementations, communicating with the accessory device includes using a RF signal to communicate data to and/or from the accessory device. For example, the RF signal can be a BLUETOOTH signal, a WIFI signal, a NFC signal, or another RF signal. In other implementations, communicating with the accessory device includes detecting a capacitance pattern of the accessory device with a touch-sensitive or capacitive panel in the display. In yet other implementations, communicating with the accessory device includes using an optical signal to communicate data to and/or from the accessory device.

The electronic device includes a display, and a dial (or other accessory device) is positioned on the display. In some implementations, the dial has a unique capacitive pattern that is detected by a capacitive panel in the display. The processor of the electronic device can compare the capacitive pattern to a device database, stored on a local storage device or on a remote storage device, to identify the accessory device and access device information about the accessory device. The device information informs the electronic device of a contact surface size and shape of the dial.

In some implementations, the area of the charging portion of the display is smaller than the area of the contact surface. In some examples, the charging portion is within a perimeter of the contact surface to limit and/or prevent light bleed of an output light from underneath and/or around the dial.

For example, the charging portion is illustrated as illuminated by an output light that is within a perimeter of the contact surface. The display can, thereby, provide the output light to the dial while no extraneous output light is visible to a user. Additionally, light bleed indicates that a portion of the output light is not directed at or collected by the photovoltaic panel of the accessory device. In such instances, the portion of the output light that bleeds around the accessory device is wasted energy that is not being harvested to charge the accessory device. Additionally, by providing the output light in only the charging portion of the display, the electronic device consumes less energy and charges the accessory device more efficiently that merely positioning a photovoltaic-powered accessory device at or near a conventional display.

When the dial is fully charged, the electronic device communicates with the dial to determine that the dial is charged. In some implementations, a capacitive pattern changes into a charged capacitive pattern to indicate the dial is charged. The display detects the charged capacitive pattern, and, recognizing the capacitive pattern has changed, then stops emitting the output light to charge the dial.

In some implementations, when the display stops emitting the output light in the charging portion, the electronic device synchronizes the display in the charging portion and in the remaining portion. The display then displays continuous visual information across the entire display after the accessory device is charged.

In other implementations, the communication between the accessory device and the electronic device when the accessory device is charged includes receiving an optical signal from the accessory device. In some implementations, the stylus or other accessory device has a light therein that is oriented in the direction of the contact surface. The light illuminates and/or flashes to communicate an optical signal to the display that is detected by a photoreceptor array or other photosensitive panel in the display. The photoreceptor array can then communicate to the control module and/or processor of the electronic device that the stylus is charged.

In at least one implementation according to the present disclosure, optical charging of accessory devices on a display creates a seamless experience for a user by continuously charging the accessory device without any wires and without any visible change to the display or the accessory device.

The present disclosure relates to systems and methods for optically charging an accessory device using light from a display of an electronic device according to at least the examples provided in the sections below:
1. An electronic device (e.g., electronic device 200; FIG. 2) for optical charging of accessory devices, the electronic device comprising:
   a display (e.g., display 202; FIG. 2) having a backlight (e.g., backlight 210; FIG. 2);
   a control module (e.g., control module 214; FIG. 2) in data communication with the display and backlight and configured to control the wavelength and luminance of the display;
   a processor (e.g., processor 212; FIG. 2) in data communication with the control module; and
   a hardware storage device (e.g., storage device 216; FIG. 2) in data communication with the processor, the hardware storage device having instructions stored thereon that, when executed by the processor, cause the processor to:
      detect (e.g., detecting . . . 436; FIG. 4) an accessory device in proximity to a portion of the display;
      identify a charging portion of the display based on the location of the accessory device, and
      adjust (e.g., adjusting . . . 438; FIG. 4) the display to provide output light from a charging portion of the display in proximity to the accessory device independently of a remaining portion of the display to charge the accessory device.
2. The electronic device (e.g., electronic device 200; FIG. 2) of section 1, wherein the display is a capacitive touch-sensitive device (e.g., touch-sensitive panel 324; FIG. 3-1), and the capacitive touch-sensitive device is used to detect the accessory device (e.g., stylus 304; FIG. 3-1).
3. The electronic device (e.g., electronic device 200; FIG. 2) of section 2 the instructions further comprising identifying a capacitive pattern (e.g., capacitive pattern 542; FIG. 5-1) of the accessory device and identifying the accessory device based on the capacitive pattern.
4. The electronic device of claim 1, wherein the instructions further cause the processor to communicate (e.g., communicating . . . 440; FIG. 4) with the accessory device to determine when charging is complete.
5. The electronic device (e.g., electronic device 200; FIG. 2) of any of sections 1-4, wherein the charging portion (e.g., charging portion 526; FIG. 5-1) of the display in proximity to the accessory device has an area smaller than a contact surface (e.g., contact surface 523; FIG. 5-1) of the accessory in contact with the display.
6. The electronic device (e.g., electronic device 200; FIG. 2) of any of sections 1-5, wherein adjusting the display includes increasing the luminance of the display in the charging portion of the display in proximity to the accessory device.
7. The electronic device (e.g., electronic device 200; FIG. 2) of any of sections 1-6, wherein adjusting the display includes selecting a wavelength of output light from the charging portion of the display in proximity to the accessory device.
8. A method (e.g., method 434) of providing power to an accessory device with a display of an electronic device, the method comprising:
   at the electronic device:
      detecting (e.g., detecting . . . 436; FIG. 4) the accessory device in proximity to a portion of a display of the electronic device;
      adjusting (e.g., adjusting . . . 436; FIG. 4) the display to provide output light from a charging portion of the display in proximity to the accessory device independently of a remaining portion of the display to charge the accessory device; and
      communicating (e.g., communicating . . . 436; FIG. 4) with the accessory device to determine when charging is complete.
9. The method (e.g., method 434) of section 8, wherein detecting the accessory device includes detecting a capacitive pattern (e.g., capacitive pattern 542; FIG. 5-1) with a touch-sensitive panel (e.g., touch-sensitive panel 324; FIG. 3-1) of the electronic device.
10. The method (e.g., method 434) of section 8 or 9, wherein detecting the accessory device includes detecting force applied to the electronic device with a touch-sensitive panel (e.g., touch-sensitive panel 324; FIG. 3-1).
11. The method (e.g., method 434) of any of sections 8-10, wherein detecting the accessory device includes establishing a radio frequency (RF) data communication (e.g., wireless signal 219; FIG. 2) between the electronic device and the accessory device.
12. The method (e.g., method 434) of any of sections 8-11, wherein detecting the accessory device includes detecting an accessory device contact surface shape (e.g., contact surface 523; FIG. 5-1), a charging portion shape (e.g., charging portion 526; FIG. 5-1) being complementary to the accessory device contact surface shape.
13. The method (e.g., method 434) of section 12, wherein an area of the charging portion (e.g., charging portion 526; FIG. 5-1) is smaller than a contact surface (e.g., contact surface 523; FIG. 5-1) of the accessory device in contact with the display such that the output light (e.g., output light 544; FIG. 5-2) does not bleed around the accessory device.
14. The method (e.g., method 434) of any of sections 8-13, wherein the remaining portion (e.g., remaining portion 328; FIG. 3-2) of the display is black while providing the output light (e.g., output light 544; FIG. 5-2).
15. The method (e.g., method 434) of any of sections 8-14, wherein the electronic device is in a standby mode while charging the accessory device.
16. The method (e.g., method 434) of any of sections 8-15 further comprising synchronizing a state of the charging portion (e.g., charging portion 526; FIG. 5-4) to the remaining portion (e.g., remaining portion 528; FIG. 5-4) when charging is complete.
17. A system for optically charging an accessory with a display, the system comprising:
   a display (e.g., display 202; FIG. 2) having a backlight (e.g., backlight 210; FIG. 2);
   an accessory device (e.g., stylus 104, eraser 106, dial 108; FIG. 1) positioned in contact with the display, the accessory device having a photovoltaic panel (e.g., photovoltaic panel 330; FIG. 3-3) on a contact surface (e.g., contact surface 323; FIG. 3-3) thereof;
   a control module (e.g., control module 214; FIG. 2) in data communication with the display and backlight and configured to control the wavelength and luminance of the display;
   a processor (e.g., processor 212; FIG. 2) in data communication with the control module; and
   a hardware storage device (e.g., storage device 216; FIG. 2) in data communication with the processor, the hardware storage device having instructions stored thereon that, when executed by the processor, cause the processor to:
      detect (e.g., detecting . . . 436; FIG. 4) an accessory device in proximity to a portion of the display;
      adjust (e.g., adjusting . . . 438; FIG. 4) the display to provide output light from a charging portion of the display in proximity to the accessory device independently of a remaining portion of the display to charge the accessory device; and
      communicate (e.g., communicating . . . 440; FIG. 4) with the accessory device to determine when charging is complete.
18. The system of section 17, wherein the accessory device is magnetically attracted to the display.
19. The system of section 17 or 18, wherein the accessory device communicates with the display by changing a capacitive pattern (e.g., charged capacitive pattern 542-2; FIG. 5-4) of the accessory device.
20. The system of any of sections 17-19, further comprising a communication device in data communication with the processor and in wireless data communication with the accessory device.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. An electronic device for optical charging of accessory devices, the electronic device comprising:
a display having a backlight;
a control module in data communication with the display and the backlight and configured to control a wavelength and a luminance of the display;
a processor in data communication with the control module; and
a hardware storage device in data communication with the processor, the hardware storage device having instructions stored thereon that, when executed by the processor, cause the processor to:
detect an optically-chargeable accessory device in a location proximate to a portion of the display,
identify a charging portion of the display based on the location of the accessory device, and
adjust the display to provide output light from the charging portion independently of a remaining portion of the display so as to charge the accessory device, wherein the remaining portion is configured to display visual information independently of the charging portion.

2. The electronic device of claim 1, wherein the display is a capacitive touch-sensitive device, and the capacitive touch-sensitive device is used to detect the accessory device.

3. The electronic device of claim 2, the instructions further comprising detecting a capacitive pattern of the accessory device and identifying the accessory device based on the capacitive pattern.

4. The electronic device of claim 1, wherein the instructions further cause the processor to communicate with the accessory device to determine whether charging is required.

5. The electronic device of claim 1, wherein the charging portion of the display in proximity to the accessory device has an area smaller than a contact surface of the accessory in contact with the display.

6. The electronic device of claim 1, wherein adjusting the display includes increasing the luminance of the display in the charging portion of the display in proximity to the accessory device.

7. The electronic device of claim 1, wherein adjusting the display includes selecting a wavelength of output light from the charging portion of the display in proximity to the accessory device.

8. A method of providing power to an accessory device with a display of an electronic device, the method comprising:
at the electronic device:
displaying visual information on the display;
detecting the accessory device in proximity to a portion of the display of the electronic device;
adjusting the display to provide output light from a charging portion of the display in proximity to the accessory device independently of a remaining portion of the display to charge the accessory device;
displaying the visual information on the remaining portion of the display; and
communicating with the accessory device to determine when charging is complete.

9. The method of claim 8, wherein detecting the accessory device includes detecting a capacitive pattern with a touch-sensitive panel of the electronic device.

10. The method of claim 8, wherein detecting the accessory device includes detecting force applied to the electronic device with a touch-sensitive panel.

11. The method of claim 8, wherein detecting the accessory device includes establishing a radio frequency (RF) data communication between the display and the accessory device.

12. The method of claim 8, wherein detecting the accessory device includes detecting an accessory device shape, a charging portion shape being complementary to the accessory device shape.

13. The method of claim 12, wherein an area of the charging portion is smaller than a contact surface of the accessory device in contact with the display such that the output light does not bleed around the accessory device.

14. The method of claim 8, wherein the remaining portion of the display is off, or in a low power mode, while providing the output light from the charging portion.

15. The method of claim 8, wherein the display is in a standby mode while charging the accessory device.

16. The method of claim 8 further comprising synchronizing a state of the charging portion to the remaining portion in accordance with a determination that charging is complete.

17. A system for optically charging an accessory with a display, the system comprising:
a display having a backlight;
an accessory device positioned in contact with the display, the accessory device having a photovoltaic panel on a contact surface thereof;
a control module in data communication with the display and the backlight and configured to control a wavelength and a luminance of the display;
a processor in data communication with the control module; and
a hardware storage device in data communication with the processor, the hardware storage device having instructions stored thereon that, when executed by the processor, cause the processor to:
display visual information on the display;
detect the accessory device in proximity to a portion of the display;
adjust the display to provide output light from a charging portion of the display in proximity to the accessory device independently of a remaining portion of the display to charge the accessory device;
display the visual information on the remaining portion of the display; and
communicate with the accessory device to determine when charging is complete.

18. The system of claim 17, wherein the accessory device is magnetically attracted to the display.

19. The system of claim 17, wherein the accessory device communicates with the display by changing a capacitive pattern of the accessory device.

20. The system of claim 17 further comprising a communication device in data communication with the processor and in wireless data communication with the accessory device.
